(19) United States
(12) Patent Application Publication
(10) Pub. No.: US 2008/0110529 A1
(43) Pub. Date: May 15, 2008

(54) Device With A Profiled Rail And At Least One Fastening Element

(76) Inventor: Jan Breitenbach, Stuttgart (DE)

Correspondence Address: MICHAEL J. STRIKER, 103 EAST NECK ROAD, HUNTINGTON, NY, 11743, US

(21) Appl. No.: 11/813,431

(22) PCT Filed: Aug. 28, 2006
(86) PCT No.: PCT/EP06/65715

§ 371 Date: Jul. 6, 2007

(30) Foreign Application Priority Data
Oct. 24, 2005 (DE) 10 2005 050 783.2

(51) Int. Cl. B25H 1/00

(52) U.S. Cl. 144/287

(57) ABSTRACT

The invention relates to a device comprising a profiled rail (10) and at least one fastening element (12) for fixing a machine tool and/or a workpiece to the profiled rail (10). The fastening element (12) is provided with at least one clamping jaw (22, 24) and a clamping means (26) that is effectively connected to the clamping jaw (22) in order to brace the clamping jaw (22) with the profiled rail (10). According to the invention, the clamping means (26) is embodied as an eccentric lever.

### RELATED ART

The present invention relates to a device with a profiled rail and at least one fastening element according to the preamble of claim 1.

Publication US 2004/0221923 A1 makes known a device with a profiled rail and two fastening elements for mounting a machine tool and/or a work piece on the profiled rail. Each of the fastening elements includes two clamping jaws, and a first clamping jaw is operatively connected with a spring. The spring serves as clamping means for clamping the clamping jaw onto the profiled rail.

### ADVANTAGES OF THE INVENTION

The present invention relates to a device with a profiled rail and at least one fastening element of a machine tool and/or a work piece on the profiled rail. The fastening element is provided to grip the sides of the profiled rail; it includes at least one clamping jaw and clamping means operatively connected with the clamping jaw for clamping the clamping jaw onto the profiled rail.

It is provided that the clamping means are designed as an eccentric lever.

By using leverage to produce a clamping force, a stable hold with a strong clamping force can be attained in a comfortable manner and, in particular, without the use of tools. Advantageously, the fastening element can be prevented from accidentally becoming detached from the profiled rail, which can be dangerous, and which can occur, e.g., with clamped connections produced by spring force. Safety risks can therefore be eliminated when mounting machine tools, in particular, such as circular saws, cross saws or mitre saws.

The eccentric lever can include an eccentric cam or a pin or bolt that is positioned eccentrically relative to a fixed swivel axis of the eccentric lever.

A particularly secure hold can be attained when the clamping means are provided to fix the clamping jaw in a clamped position in a form-fit manner. In this context, the term “provided” should be understood to also mean “designed” and “equipped”. The clamped position of the clamping jaw is characterized, in particular, by a clamping surface of the clamping jaw bearing against a corresponding mounting surface of the profiled rail with a contact force or clamping force.

A particularly robust fastening element is obtainable when the clamping means are supported in the fastening element such that they are displaceable along a straight line. Highly stressed pivot axes can be prevented in particular.

When a maximum displacement travel of the clamping means is at least so great that the fastening element can be lifted off of the profiled rail when the clamping means are in a released position, the fastening means or machine tool can be connected with the profiled rail in a particularly rapid and convenient manner.

A particularly dust-resistant fastening device as can be attained using simple design means when the operative connection between the clamping jaw and the clamping means is produced by an eccentric cam integrally formed on the clamping means.

In an alternative embodiment of the present invention, the operative connection between the clamping jaw and the clamping means is produced by a connecting rod that is connected eccentrically with the clamping means. As a result, a transfer of force via a body of the fastening element can be prevented.

When the device includes safety locking means for securing the clamping jaw in a clamped position, the clamping means can be effectively prevented from becoming accidentally released.

When the safety locking means automatically engage in the clamping means when the clamped position is reached, it can be ensured that the device cannot be used without actuating the safety locking means. In particular, when the clamping jaw is fixed in its clamped position by the clamping means in a form-fit manner, the leverage of the clamping means can improve the effect of the safety locking means, and, in fact, compared with embodiments of the present invention with which the safety locking means engage in the clamping jaw directly.

In an alternative embodiment of the present invention, the safety locking means engage in the connecting rod.

When the device includes a second clamping jaw with a clamping surface designed as mirror image—relative to a plane of symmetry of the profiled rail—of a clamping surface of the first clamping jaw, it is possible to choose any orientation of the fastening element relative to the profiled rail. As a result, the device can be adapted to various applications in a more flexible manner. In addition, asymmetric wear can be prevented.

A particularly large variety of machine tools and/or work pieces can be mounted on the profiled rail using the fastening element when the device includes at least one threaded plate that is displaceable relative to a frame of the fastening element. By displacing the threaded plate, the fastening element can be adapted to various hole patterns in the machine tool and/or the work piece without the need to create additional holes.

Particularly easy installation of the fastening element on the machine tool and/or the work piece can be attained when the displaceable threaded plate is accessible from both sides of the frame of the fastening element, and/or when the frame includes an engagement recess in the region of the displaceable threaded plate. The device can form a complete, portable work bench when the profiled rail is equipped with collapsible support legs. User comfort can be enhanced further when the profiled rail is equipped with a handle.

When the profiled rail includes a holding device for holding a screw tool, transport and set-up of the device, e.g., at a work site, can be simplified.

When the profiled rail includes a fastening groove for mounting a machine tool and/or a work piece, the spectrum of applications for the profiled rail can be expanded.

Transport can be made even more comfortable when the profiled rail is equipped with a handle.

### DRAWING

Further advantages result from the description of the drawing, below. Exemplary embodiments of the present invention are shown in the drawing. The drawing, the description and the claims contain numerous features in combination. One skilled in the art will also advantageously consider the features individually and combine them to form further reasonable combinations.

FIG. 1 shows a portable work bench with a profiled rail and two fastening elements,

FIG. 2 shows one of the fastening elements in FIG. 1,

FIG. 3 shows the fastening element in FIG. 2, in a view diagonally from below,

FIG. 4 shows clamping means of the fastening element and safety locking means, in a detailed view,

FIG. 5 shows a handle of the profiled rail in FIG. 1,

FIG. 6 shows the profiled rail, the fastening element, and clamping means in a clamped position,

FIG. 7 shows the profiled rail, the fastening element, and clamping means in a released position,

FIG. 8 shows a profiled rail and an alternative fastening element, in a clamped

FIG. 9 shows the profiled rail and the fastening element in FIG. 8 in a released position.

### DESCRIPTION OF THE EXEMPLARY EMBODIMENTS

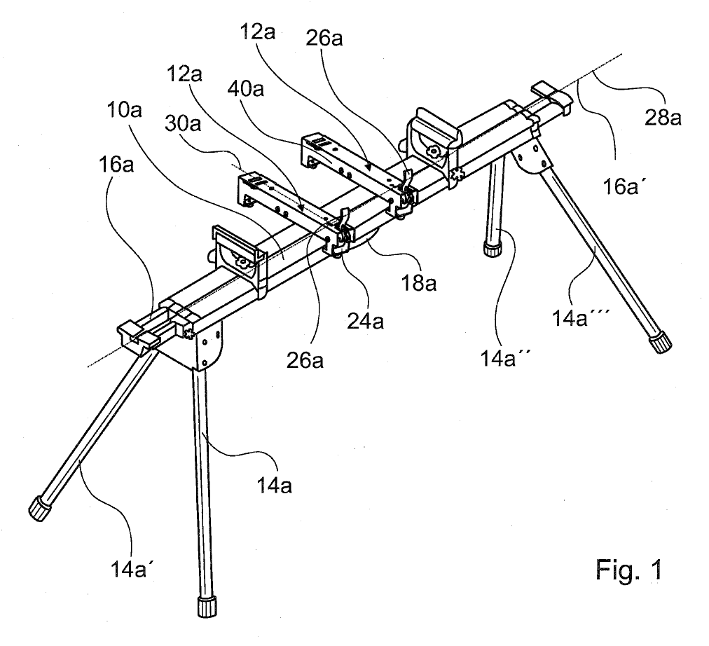

FIG. 1 shows a portable work bench with a profiled rail 10a made of aluminium, which is equipped with collapsible support legs 14a-14a′″, two extensions 16a, 16a′, and a handle 18a. Extension 16a can be slid into profiled rail 10a, and support legs 14a-14a′″ can be folded inward, thereby enabling the work bench to be transported as a compact unit. One of the support legs 14a is designed to be height-adjustable, in order to attain good stability on uneven ground.

Portable work bench includes two fastening elements 12a, 12a′, which can be clamped onto profiled rail 10a. Any type of machine tool, particularly electrical machine tools, and work pieces can be screwed onto fastening elements 12a, 12a′, or they can be connected with fastening elements 12a, 12a′ in any other manner deemed suitable by one skilled in the art. The machine tool or the work piece can then be connected with profiled rail 10a comfortably and rapidly using fastening elements 12a, 12a′.

Fastening element 12a includes—on its underside 20a facing profiled rail 10a—a first, movable clamping jaw 22a and a second, fixed clamping jaw 24a. Clamping means 26a operatively connected with first, movable clamping jaw 22a are located at one end of longitudinal fastening element 12a and are designed as a pivotable eccentric lever capable of pivoting around a pivot axis 32a extending parallel to a longitudinal axis 28a of profiled rail 10a.

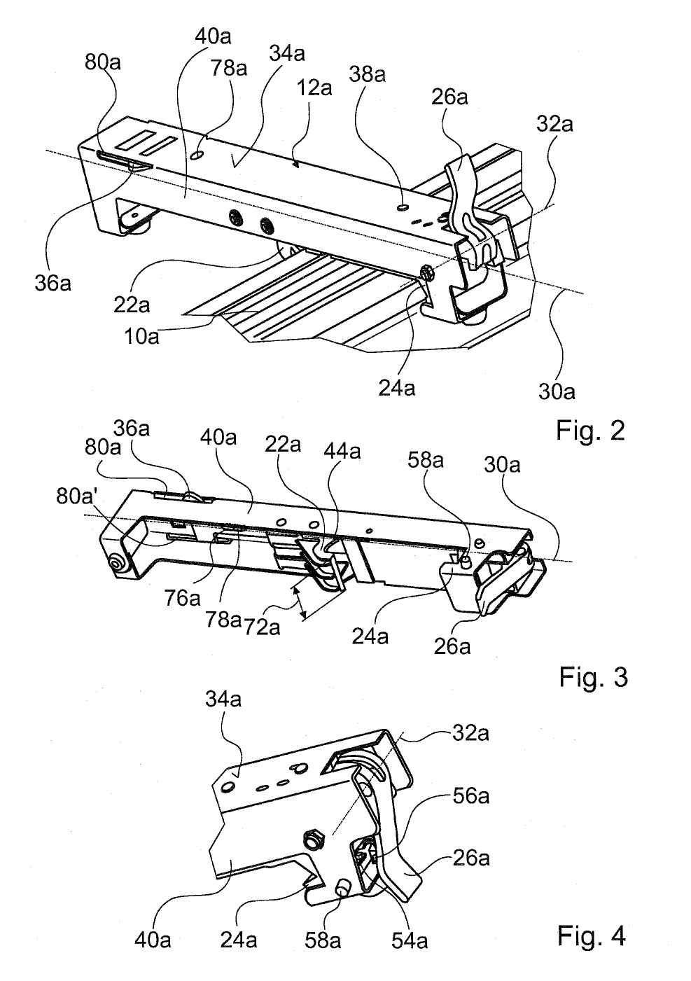

A top side 34a of fastening element 12a that faces away from profiled rail 10a when in the installed state includes a first threaded plate 36a capable of being displaced along longitudinal axis 30a of fastening element 12a and along longitudinal axis 28a of profiled rail 10a, and a second threaded plate 38a, which is fixed in position relative to a frame 40a of fastening element 12a (FIG. 2). Displaceable threaded plate 36a is connected via a slot 76a and a bolt 78a engaged in slot 76a with frame 40a, and has a T-shaped design overall (FIG. 3). The ends of the crossbar of the T shape extend laterally through slits 80a, 80a′ in frame 40a. As a result, the mobility of threaded plate 36a relative to a swivel motion around bolt 78a is limited by the ends of slits 80a, 80a′. The amount of play that threaded plate 36a has in the direction of longitudinal axis 30a of fastening element 12a is limited by the length of slot 76a. The machine tool or work piece to be mounted can be screwed together with both threaded plates 36a, 38a via bore holes. The user can thereby adapt the position of first, displaceable threaded plate 36a to a hole pattern of the machine tool or the work piece. Due to the threads provided in threaded plates 36a, 38a, bolts—which could easily become lost—need not be used when screwing the machine tool into place. In a cutting plane extending transversely to a longitudinal axis 30a of fastening element 12a, the latter has a U-shaped profile that opens downward in the direction toward profiled rail 10a, thereby enabling threaded plates 36a, 38a located in the region of top side 34a of fastening element 12a to be accessed freely from below to screw the machine tool or the work piece into place.

First clamping jaw 22a is supported in fastening element 12a such that it can be displaced along a straight line, and it is connected with clamping means 26a via a connecting rod 42a. Connecting rod 42a is connected with clamping means 26a via a bolt such that it can pivot around pivot axis 32a. Clamping means 26a include an eccentric cam 66a, which bears against a support tab 74a of frame 40a, thereby enabling a swiveling motion of clamping means 26a to be transferred—by eccentric cam 66a gliding over support tab 74a—into a reciprocating motion of connecting rod 42a and clamping jaw 22a connected via a connecting bolt with connecting rod 42a (FIGS. 6 and 7). A return spring 68a automatically returns clamping jaw 22a from an intermediate position to the opened position and, in the opened position, it generates a contact force of eccentric cam 66a on support tab 74a. To attain horizontal guidance and a vertical hold of connecting rod 42a, the latter is guided through a hole—which is not shown explicitly here—in support tab 74a.

Clamping jaws 22a, 24a include clamping surfaces 44a, 46a designed as mirror images of each other, which bear against fastening ridges 48a, 50a of profiled rail 10a in a clamped position (FIG. 6). Clamping surfaces 44a, 46a grip partially around fastening ridges 48a, 50a, so that fastening element 12a—when in the clamped position—is connected in a form-fit manner with profiled rail 10a in a vertical direction and in a direction that extends perpendicularly to longitudinal axis 28a of profiled rail 10a and to longitudinal axis 30a of fastening elements 12a. A width 72a (FIG. 3) of clamping surfaces 44a, 46a along longitudinal axis 28a of profiled rail 10a is a few centimeters, particularly more than three centimeters, so that clamping jaws 22a, 24a automatically become oriented at a right angle with profiled rail 10a when they are clamped thereon. Given that a length 52a of first, movable clamping jaw 22a is greater than width 72a of clamping surface 44a, 46a and, in particular, is greater than five centimeters, clamping jaw 22a can be effectively prevented from tilting within frame 40a of fastening element 12a via a large mounting surface, thereby ensuring parallelism between clamping jaw 22a and fastening element 12a, and therefore ensuring that a right angle is formed between longitudinal axis 28a of profiled rail 10a and longitudinal axis 30a of fastening element 12a in the clamped state.

Safety locking means 54a with an integrally formed pin 56a, which are spring-loaded, rod-shaped, and displaceable parallel to longitudinal axis 28a of profiled rail 10a, are located in the region of clamping means 26a, and they automatically engage in clamping means 26a when clamping means 26a reach the clamped position (FIG. 4).

Shortly before the clamped position is reached, the reciprocating motion of connecting rod 42a passes an apex, so that clamping means 26a fix clamping jaw 22a in the clamped position in a form-fit manner. In the clamped position, a bore hole in clamping means 26a overlaps a pin 56a of safety locking means 54a, so that the latter automatically snaps into place and engages in clamping means 26a. To release clamping means 26a, a user can push safety locking means 54a back against the force of a spring by pressing on an end 58a of safety locking means 54, thereby allowing clamping means 26a to be released.

In an alternative embodiment of the present invention, the safety locking means engage in connecting rod 42a.

In a released configuration, in which clamping surfaces 44a, 46a are further away from each other—by displacement travel 70a (FIG. 7)—than in the clamped position, a distance between clamping surfaces 44a, 46a is at a maximum and exceeds a maximum width 60a between fastening ridges 48a, 50a of profiled rail 10a, thereby enabling the machine tool and/or work piece to be lifted—together with fastening elements 12a, 12a′—in a vertical direction off of profiled rail 10a. Similarly, the machine tool and/or work piece can be placed on profiled rail 10a in the vertical direction when clamping means 26a are released.

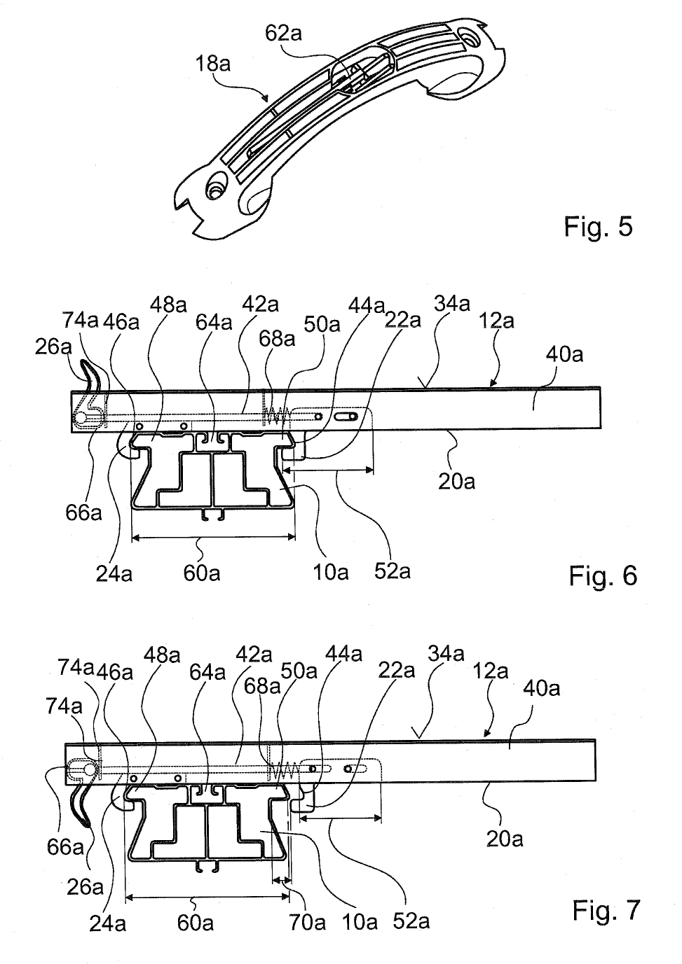

FIG. 5 shows a handle 18a, which is screwed onto profiled rail 10a from below. Handle 18a is designed as a plastic, injection-molded part, and simultaneously serves as a retaining means for holding a screw tool 62a, i.e., an Allen wrench. On a top side that extends horizontally in the installed state, profiled rail 10a includes a fastening groove 64a for fastening machine tools with appropriate clamp-connection means. Fastening groove 64a can be used as an alternative to fastening elements 12a, 12a′.

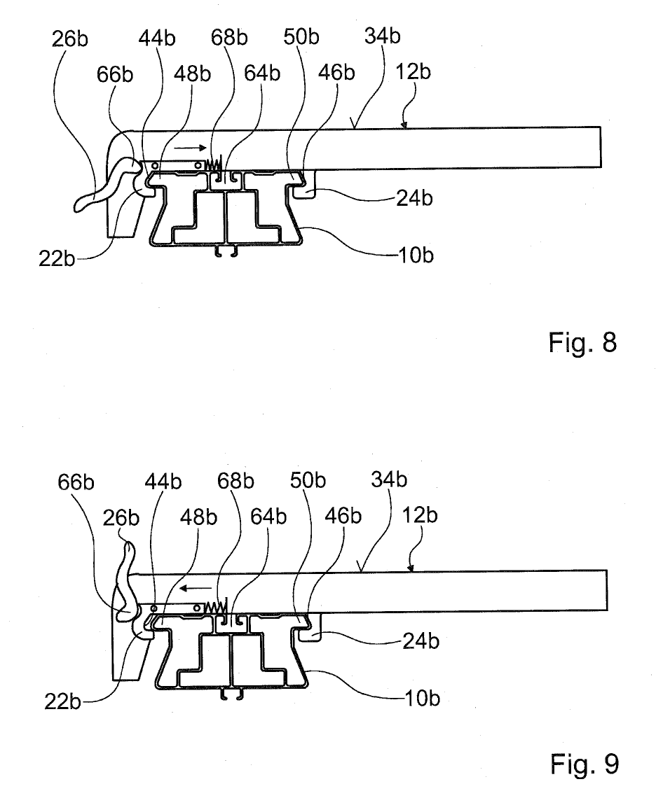

FIGS. 8 and 9 show an alternative embodiment of the present invention. The description mainly addresses the differences between the exemplary embodiments shown in FIGS. 1 through 7. Similar features are labeled with the same reference numerals. To distinguish the exemplary embodiments from each other, the reference numerals are appended with the letters “a” and “b”.

An operative connection that exists between clamping means 26b and a first, movable clamping jaw 22b is generated by an eccentric cam 66b integrally formed on clamping means 26b; eccentric cam 66b glides along a corresponding mounting surface of clamping jaw 22b. For clamping, clamping jaw 22b is pressed onto a profiled rail 10b in the longitudinal direction of a fastening element 12b (FIG. 8). When clamping means 26b are released, a return spring 68b moves clamping jaw 22b away from profiled rail 10b, so that fastening element 12b can be lifted off of profiled rail 10b along with the machine tool screwed in place thereon.

What is claimed is:

1. A device with a profiled rail (10) and at least one fastening element (12) for mounting a machine tool and/or a workpiece to the profiled rail (10); the fastening element (12) is provided with at least one clamping jaw (22, 24) and clamping means (26) operatively connected with the clamping jaw (22) to clamp the clamping jaw (22) onto the profiled rail (10),
wherein
the clamping means (26) are designed as an eccentric lever.

2. The device as recited in claim 1,
wherein
the clamping means (26) are provided to hold the clamping jaw (22) in a clamped position in a form-fit manner.

3. The device as recited in claim 1,
wherein
the clamping jaw (22) is supported in the fastening element (12) such that it is displaceable along a straight line.

4. The device as recited in claim 3,
wherein
a maximum displacement travel (70) of the clamping jaw (22) is at least so great that the fastening element (12) can be lifted off of the profiled rail (10) when the clamping jaw (22) is in a released position.

5. The device as recited in claim 1,
wherein
the operative connection between the clamping jaw (22) and the clamping means (26) is produced by an eccentric cam (66) integrally formed on the clamping means (26).

6. The device as recited in claim 1,
wherein
the operative connection between the clamping jaw (22a) and the clamping means (26a) is produced by a connecting rod (42a) that is connected eccentrically with the clamping means (26a).

7. The device as recited in claim 1, characterized by a safety locking means (54) for securing the clamping jaw (22) in a clamped position.

8. The device as recited in claim 2,
wherein
the safety locking means (54) automatically engage in the clamping means (26) when the clamped position is reached.

9. The device as recited in claim 1, characterized by a second clamping jaw (24) with a clamping surface (44, 46) designed as a mirror image—relative to a plane of symmetry of the profiled rail (10)—of a clamping surface (44, 46) of the first clamping jaw (22).

10. The device as recited in claim 1, characterized by at least one threaded plate (36), which is displaceable relative to a frame (40) of the fastening element (12).

11. The device as recited in claim 1,
wherein
the profiled rail (10) is equipped with collapsible support legs (14-14′″).

12. The device as recited in claim 1,
wherein
the profiled rail (10) is equipped with a holding device for holding a screw tool (62).

13. The device as recited in claim 1,
wherein
the profiled rail (10) includes a fastening groove (64) for attaching a machine tool and/or a work piece.

14. The device as recited in claim 1,
wherein
the profiled rail (10) includes a handle (18).
